(19) United States
(12) Patent Application Publication
(10) Pub. No.: US 2026/0353487 A1
(43) Pub. Date: Nov. 5, 2026

(54) COMMUNICATION DEVICE, NON-TRANSITORY COMPUTER-READABLE STORAGE MEDIUM STORING COMPUTER-READABLE INSTRUCTIONS FOR COMMUNICATION DEVICE, AND COMMUNICATION SYSTEM

(71) Applicant: BROTHER KOGYO KABUSHIKI KAISHA, Nagoya (JP)

(72) Inventor: Ryoya Tsuji, Nagoya (JP)

(21) Appl. No.: 19/549,314

(22) Filed: Feb. 25, 2026

(30) Foreign Application Priority Data
Feb. 28, 2025 (JP) 2025-031141

(51) Int. Cl. H04W 76/15; H04W 8/00; H04W 84/12

(52) U.S. Cl. CPC H04W 76/15; H04W 8/005; H04W 84/12

(57) ABSTRACT

In a state where a first communication device belongs to a first wireless network according to a Wi-Fi Aware scheme, the first communication device receives a predetermined signal by using the first wireless network from a second communication device which belongs to the first wireless network. In a case where the predetermined signal has been received from the second communication device and wireless communication is executable by using the first wireless connection between the first communication device and a specific external device, the first communication device sends connection information to the second communication device by using a second wireless network which has higher security than the first wireless network.

### REFERENCE TO RELATED APPLICATION

This application claims priority to Japanese Patent Application No. 2025-031141 filed on Feb. 28, 2025. The entire content of the priority application is incorporated herein by reference.

### BACKGROUND ART

A communication system including a communication device, a terminal device, and an access point is known. In this communication system, when communication is not executable between the communication device and the terminal device via the access point, a P2P connection such as Wi-Fi Direct (registered trademark owned by Wi-Fi Alliance) is established between the communication device and the terminal device by using, for example, Bluetooth (registered trademark owned by Bluetooth SIG.), Wi-Fi Aware, or NFC (near field communication).

### SUMMARY

The disclosure herein provides a technology for improving user convenience.

A first communication device is disclosed herein. The first communication device may include a Wi-Fi interface configured for wireless communication according to a Wi-Fi standard, a memory configured to store connection information for establishing a first wireless connection according to the Wi-Fi standard with a specific external device, and a controller. The controller may be configured to, in a state where the first communication device belongs to a first wireless network according to a Wi-Fi Aware scheme of the Wi-Fi standard, receive a predetermined signal via the Wi-Fi interface by using the first wireless network from a second communication device which belongs to the first wireless network. The controller may be configured to, in a case where the predetermined signal has been received from the second communication device and wireless communication is executable by using the first wireless connection between the first communication device and the specific external device, send the connection information in the memory to the second communication device via the Wi-Fi interface by using a second wireless network which has higher security than the first wireless network.

According to the configuration above, the first communication device receives the predetermined signal from the second communication device by using the first wireless network. In case the first communication device receives the predetermined signal from the second communication device and wireless communication is executable between the first communication device and the specific external device, the first communication device sends the connection information to the second communication device using the second wireless network which has higher security than the first wireless network. Thus, the first communication device can wirelessly communicate with the second communication device via the specific external device without a user inputting the connection information to the second communication device. Therefore, user convenience is improved.

Computer-readable instructions for the above first communication device, a non-transitory computer-readable storage medium storing these computer-readable instructions, and a method performed by the first communication device are also novel and useful. Here, the non-transitory computer-readable storage medium may be a single medium or a combination of media. Further, a communication system comprising the first and second communication devices is also novel and useful.

### BRIEF DESCRIPTION OF DRAWINGS

FIG. 1 is a diagram illustrating a configuration of a communication system.

FIG. 2 is a sequence diagram of a specific process.

FIG. 3 is a sequence diagram continued from FIG. 2.

FIG. 4 is a sequence diagram continued from FIG. 3.

### DESCRIPTION

### Configuration of Communication System 2

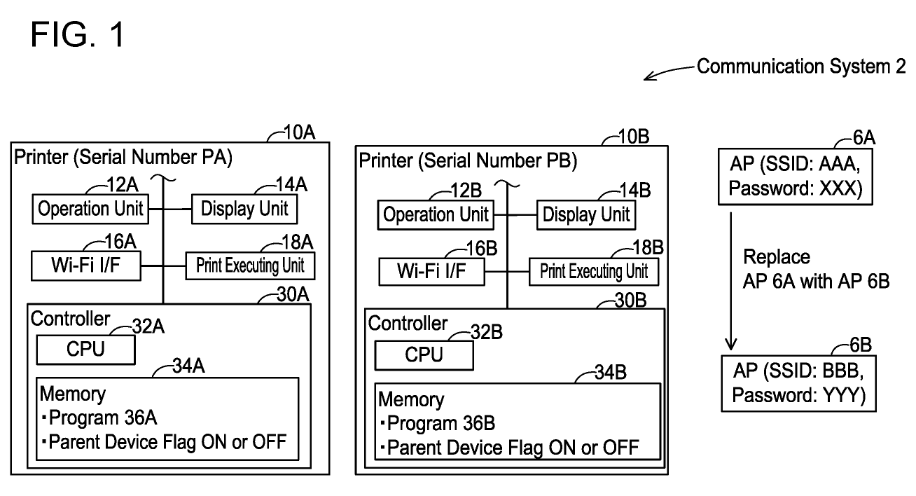

As illustrated in FIG. 1, a communication system 2 comprises an access point 6A and two printers 10A, 10B. Hereinafter, the access point is abbreviated as “AP”. The printers 10A, 10B belong to the same Neighbor Awareness Networking (NAN) cluster. A NAN cluster is a wireless network defined according to Wi-Fi Aware scheme of Wi-Fi standard. Connection information stored in the printer 10A is shared with the printer 10B by using the Wi-Fi Aware scheme. The connection information is used to establish a wireless connection with, for example, the AP 6A. For example, the connection information is a combination of a Service Set Identifier (SSID) and a password (hereinafter abbreviated as “PW”).

### Configuration of Printer 10A

The printer 10A is a peripheral device configured to execute a print function, for example, a peripheral device of a terminal (not illustrated). In a modification, the printer 10A may be a multifunctional device configured to execute functions such as a scan function and/or facsimile function in addition to the print function. A serial number “PA” for identifying the printer 10A is assigned to the printer 10A. The printer 10A comprises an operation unit 12A, a display unit 14A, a Wi-Fi interface 16A, a print executing unit 18A, and a controller 30A. The units 12A to 30A are connected to a bus line. Hereinafter, an interface is abbreviated as “I/F”.

The operation unit 12A is a user interface through which a user can input various information to the printer 10A. The operation unit 12A comprises, for example, a touch screen for displaying software keys (operation objects), hardware keys, or both of these. The hardware keys include, for example, buttons or switches. The display unit 14A is a display or panel for displaying various information. The panel may be or may not be a touch panel (touch screen). The panel is, for example, a liquid crystal panel or an organic EL panel. The print executing unit 18A comprises a print engine of inkjet scheme, electrophotographic scheme, or thermal scheme.

The Wi-Fi I/F 16A is a wireless I/F configured for Wi-Fi communication according to a Wi-Fi standard. The Wi-Fi standard is a wireless communication standard for wireless communication according to 802.11 established by IEEE (The Institute of Electrical and Electronics Engineers, Inc.) and related standards such as 802.11a, 802.11b, 802.11n, and 802.11ac. Especially, the Wi-Fi I/F 16A supports the Wi-Fi Aware scheme established by the Wi-Fi Alliance. That is, the Wi-Fi I/F 16A can execute wireless communication according to the Wi-Fi Aware scheme. The Wi-Fi Aware scheme is detailed in the specification “Wi-Fi Aware Specification Version 4.0” created by the Wi-Fi Alliance. Wi-Fi Aware is also called as Wi-Fi Neighbor Awareness Networking (NAN).

The devices 10A, 10B can join a NAN cluster according to the Wi-Fi Aware scheme, which will be detailed later. Devices in the same NAN cluster synchronize their Discovery Windows, which are periods for sending and receiving signals. Communication using a NAN cluster is communication that uses the data link layer and lower layers and does not use the network layer or higher layers of the OSI reference model.

Each of devices within a NAN cluster plays any one of the following roles: a Master, an Anchor Master, and a Non-Master. A Master is capable of sharing timer information, searching for services, and inviting device(s) to the NAN cluster. In addition to the Master’s functions, an Anchor Master is also capable of setting timer information for synchronization. A Non-Master is capable of sharing timer information and searching for services but incapable of inviting device(s) to the cluster.

Each device within the NAN cluster can search for another device, more specifically, a service provided by another device, within the NAN cluster. A signal for this service search is called Subscribe. A device sends a response signal called Publish in response to receiving a Subscribe. In this embodiment, the printer 10B sends a Subscribe for searching for another device that can provide a setting synchronization service. The setting synchronization service is a service for sharing information (e.g., connection information used to establish a wireless connection with an AP) stored in a device with another device. The Subscribe is broadcast within the NAN cluster. Since the printer 10A can provide the setting synchronization service, the printer 10A sends a Publish to the printer 10B in response to receiving the Subscribe from the printer 10B.

The Wi-Fi I/F 16A can also execute wireless communication according to normal Wi-Fi scheme different from the Wi-Fi Aware scheme. Generally, wireless communication according to the normal Wi-Fi scheme uses an AP, while wireless communication according to the Wi-Fi Aware scheme does not use an AP. For example, the printer 10A can join a normal Wi-Fi network by establishing a wireless connection with an AP. Hereinafter, a wireless connection with an AP is termed “AP connection”. The printer 10A can wirelessly communicate with devices within the normal Wi-Fi network via an AP.

The controller 30A comprises a CPU 32A and a memory 34A. The memory 34A comprises a main storage and an auxiliary storage. The main storage includes a RAM and a cache memory, although this is merely an example. The auxiliary storage may be a ROM, a flash memory, a Solid State Drive (SSD), a Hard Disk Drive (HDD), or any combination thereof, although this is merely an example. A program 36A and a parent device flag are stored in the auxiliary storage of the memory 34A. The CPU 32A executes various processes according to the program 36A loaded from the auxiliary storage to the main storage.

The parent device flag selectively indicates either “ON” which means the printer 10A operates as a parent device for the setting synchronization service or “OFF” which means the printer 10A operates as a child device for the setting synchronization service. Here, “a parent device for the setting synchronization service” means a device that sends information to be shared, and “a child device for the setting synchronization service” means a device that receives information to be shared. That is, in the setting synchronization service, information stored in a parent device is sent from the parent device to a child device, so that the information stored in the parent device is shared with the child device. The parent device flag indicates “OFF” by default.

### Configuration of Printer 10B

The printer 10B comprises an operation unit 12B, a display unit 14B, a Wi-Fi I/F 16B, a print executing unit 18B, and a controller 30B. The units 12B to 30B are connected to a bus line. The configuration of the printer 10B is the same as that of the printer 10A except that a serial number “PB” is assigned to the printer 10B. That is, the units 12B to 30B of the printer 10B are the same as the units 12A to 30A of the printer 10A, respectively.

### Configuration of AP 6A

The AP 6A is a normal access point called a wireless access point or a wireless LAN router. The AP 6A relays communication between a pair of devices within a wireless network in which the AP 6A operates as the parent station. The AP 6A stores an SSID “AAA” and a PW “XXX”. The SSID “AAA” is information for identifying the wireless network formed by the AP 6A. The PW “XXX” is authentication information used in the wireless network.

### Configuration of AP 6B

An AP 6B stores an SSID “BBB” different from the SSID “AAA”. The AP 6B also stores a PW “YYY” different from the PW “XXX”. Except for these differences, the configuration of the AP 6B is the same as that of the AP 6A.

### Process Executed between Devices

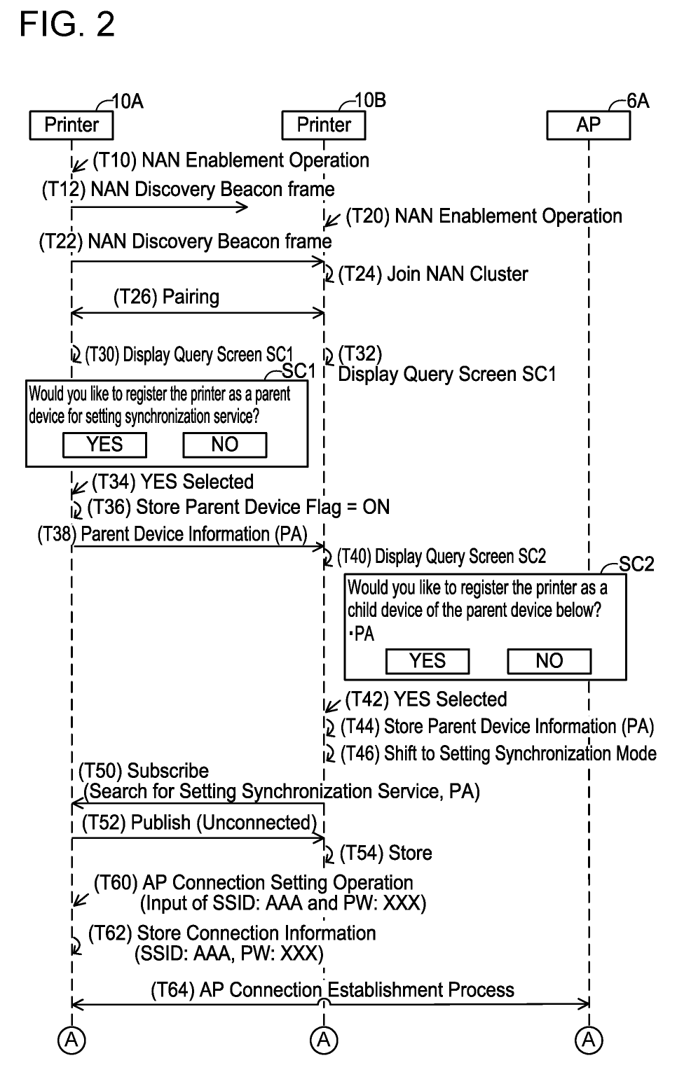

Referring now to FIGS. 2-4, a process executed by the devices is described. In the following description, for ease of understanding, steps performed by the CPU 32A of the printer 10A and the CPU 32B of the printer 10B are described as being performed by the printers rather than by the CPUs. Communications between the devices are executed via the Wi‑Fi I/Fs 16A and 16B. Accordingly, in the following description, the phrase “via the Wi‑Fi I/F” is omitted when referring to communications.

In the initial state of FIG. 2, the printer 10A has not established an AP connection with either the AP 6A or the AP 6B yet. That is, the printer 10A does not store connection information yet. Similarly, the printer 10B has not established an AP connection with either the AP 6A or the AP 6B yet. That is, the printer 10B does not store connection information yet, either.

In T10, the printer 10A receives a NAN enablement operation from a user. In response, the printer 10A shifts from a NAN-disabled state to a NAN-enabled state. Here, “NAN-disabled state” means a state of being unable to communicate signals according to the Wi-Fi Aware scheme, and “NAN-enabled state” means a state of being able to communicate signals according to the Wi-Fi Aware scheme. After shifting to the NAN-enabled state, the printer 10A forms a NAN cluster. That is, a NAN cluster to which only the printer 10A belongs is formed in T10. In this NAN cluster, the printer 10A operates as an Anchor Master.

In T12, the printer 10A broadcasts a NAN Discovery Beacon frame (hereinafter referred to simply as “Discovery”). The Discovery is a signal according to the Wi-Fi Aware scheme that notifies external devices of information about the NAN cluster to which the printer 10A belongs. Devices out of the NAN cluster can join the NAN cluster after receiving the Discovery. That is, the Discovery can be regarded as a signal for inviting devices out of the NAN cluster to join the NAN cluster. The printer 10A periodically sends a Discovery while being in the NAN-enabled state.

In T12, the printer 10B is in the NAN-disabled state. Thus, the printer 10B does not receive the Discovery from the printer 10A in T12.

In T20, the printer 10B receives the NAN enablement operation from the user. In response, the printer 10B shifts from the NAN-disabled state to the NAN-enabled state. After shifting to the NAN-enabled state, the printer 10B forms a NAN cluster. That is, a NAN cluster to which only the printer 10B belongs is formed in T20. In this NAN cluster, the printer 10B operates as an Anchor Master. Thus, at the time of T20, the NAN cluster to which only the printer 10A belongs and the NAN cluster to which only the printer 10B belongs exist.

In T22, the printer 10A broadcasts a Discovery. Since the printer 10B is in the NAN-enabled state in T22, the printer 10B receives the Discovery from the printer 10A in T22. In response, the printer 10B joins the NAN cluster only the printer 10A belongs to in T24. As a result, the printers 10A and 10B both belong to the same NAN cluster. In this case, the NAN cluster only the printer 10B belongs to (i.e., the NAN cluster formed in T20) disappears. At the time of T24, a single NAN cluster both the printers 10A and 10B belong to exists. After joining the NAN cluster, the printer 10B communicates with the printer 10A to determine roles within the NAN cluster, although this is not illustrated. In the present case, the printer 10A operates as an Anchor Master, and the printer 10B operates as a Non-Master.

In T26, pairing is executed between the printer 10A and the printer 10B. This allows the printers 10A and 10B to execute secure communication using authentication.

After the pairing between the printer 10A and the printer 10B is completed, the printer 10A displays a query screen SC1 on the display unit 14A in T30. The query screen SC1 queries the user as to whether to register the printer 10A as the parent device for the setting synchronization service. The query screen SC1 includes a message querying the user as to whether to register the printer 10A as the parent device for the setting synchronization service, a YES button, and a NO button.

After the pairing between the printer 10A and the printer 10B is completed, the printer 10B also displays a query screen SC1 on the display unit 14B in T32. This query screen SC1 is the same as the query screen SC1 displayed in T30. The user can register a desired one of the printers 10A and 10B as the parent device.

In the present case, the user registers the printer 10A as the parent device for the setting synchronization service. In T34, the printer 10A receives selection of the YES button in the query screen SC1 displayed on the printer 10A. In response, the printer 10A changes the parent device flag in the memory 34A from “OFF” to “ON” in T36. Then, the printer 10A sends parent device information to the printer 10B in T38. The parent device information includes the serial number “PA” of the printer 10A.

The printer 10B receives the parent device information from the printer 10A in T38. In response, the printer 10B displays a query screen SC2 on the display unit 14B instead of the query screen SC1 in T40. The query screen SC2 queries the user as to whether to register the printer 10B as a child device of the printer 10A, which is the parent device. The query screen SC2 includes a message querying the user as to whether to register the printer 10B as a child device, the serial number “PA” of the printer 10A as the parent device, a YES button, and a NO button.

The printer 10B receives selection of the YES button in the query screen SC2 from the user in T42. In response, the printer 10B stores the parent device information in the memory 34B in T44. The parent device information includes the serial number “PA” of the parent device. The parent device flag in the memory 34B of the printer 10B is maintained “OFF”.

At the time of T44, the printer 10B has not established a wireless connection with an AP. Thus, the printer 10B shifts from a normal mode to a setting synchronization mode in T46. Here, “normal mode” is a mode in which a Subscribe for searching for the setting synchronization service is not sent, and “setting synchronization mode” is a mode in which a Subscribe for searching for the setting synchronization service is sent. The printer 10B periodically sends a Subscribe using the NAN cluster.

In T50, the printer 10B sends a Subscribe using the NAN cluster. This Subscribe includes the parent device information stored in the memory 34B (i.e., the serial number “PA” of the printer 10A).

The printer 10A receives the Subscribe from the printer 10B using the NAN cluster in T50. Then, the printer 10A determines whether the serial number “PA” included in the Subscribe matches the serial number of the printer 10A itself. In the present case, the serial number “PA” included in the Subscribe matches the serial number of the printer 10A itself. As a result, the printer 10A proceeds to T52. If the serial number “PA” included in the Subscribe does not match the serial number of the printer 10A itself, the printer 10A does not proceed to T52. That is, the printer 10A proceeds to T52 only when it receives a Subscribe from the printer 10B registered as a child device of the printer 10A.

In T52, the printer 10A sends a Publish to the printer 10B using the NAN cluster. The Publish includes information indicating a current connection status of the printer 10A with an AP. As mentioned above, the printer 10A has not established an AP connection with either the AP 6A or the AP 6B at the time of T50. That is, the printer 10A does not store connection information used to establish an AP connection (i.e., a combination of an SSID and a PW) yet. Thus, the Publish sent in T52 includes information “Unconnected” which indicates a connection has not been established with an AP.

The printer 10B receives the Publish including the information “Unconnected” from the printer 10A using the NAN cluster in T52. In response, the printer 10B stores the information indicating that an AP connection has not been established between the printer 10A as the parent device and an AP in T54.

Then, the printer 10A receives an AP connection setting operation from the user in T60. The AP connection setting operation is performed to establish an AP connection with the AP 6A. The AP connection setting operation includes input of connection information of the AP 6A (i.e., the SSID “AAA” and the PW “XXX”). In T62, the printer 10A stores the input connection information (i.e., the SSID “AAA” and the PW “XXX”) in the memory 34A. Then, in T64, an AP connection process is executed to establish an AP connection between the printer 10A and the AP 6A. The AP connection process includes, for example, authentication of the connection information stored in the memory 34A. In the present case, the authentication of the connection information succeeds, so that an AP connection is established between the printer 10A and the AP 6A.

### Continuation from FIG. 2

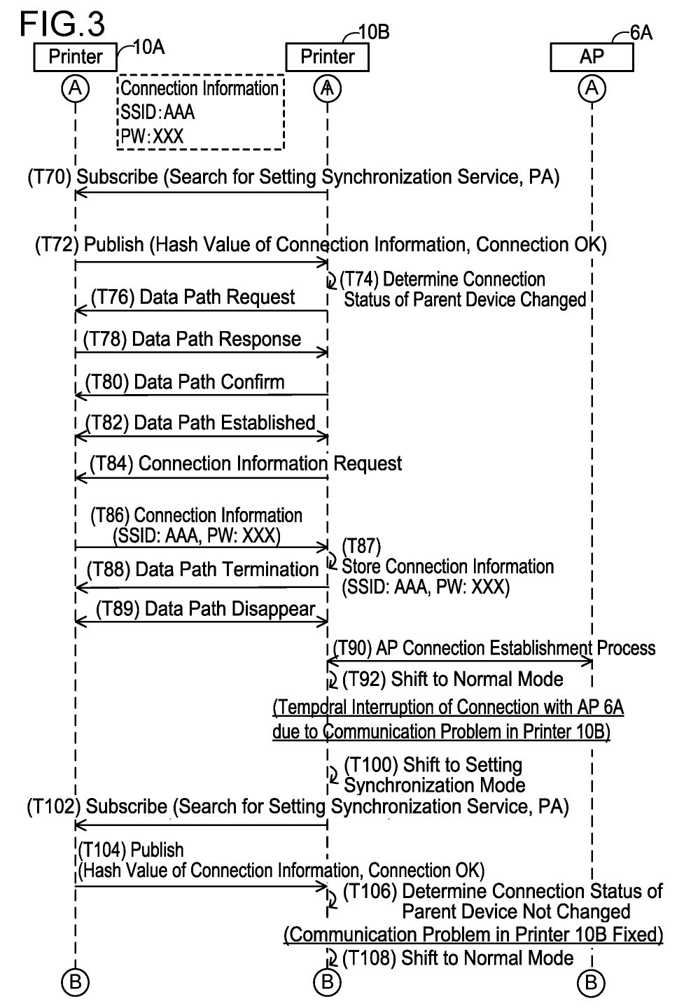

In T70 of FIG. 3, the printer 10B sends a Subscribe using the NAN cluster. This Subscribe is the same as the Subscribe sent in T50 of FIG. 2.

The printer 10A receives the Subscribe from the printer 10B using the NAN cluster in T70. The serial number “PA” included in the Subscribe matches the serial number of the printer 10A itself. Accordingly, the printer 10A sends a Publish to the printer 10B using the NAN cluster in T72. At the time of T70, the printer 10A has already established the AP connection with the AP 6A (see T64 in FIG. 2). Thus, at the time of T70, the printer 10A can wirelessly communicate with the AP 6A using the AP connection, that is, the printer 10A can execute wireless communication with the AP 6A using the network layer or higher layers of the OSI reference model. The Publish includes a hash value of the connection information stored in the memory 34A and information “Connection OK” which indicates that the printer 10A can execute wireless communication with the AP 6A. The hash value is obtained by hashing the connection information stored in the memory 34A using a hash function.

The hash value is used to determine whether connection information stored in the printer 10A is the same as connection information stored in the printer 10B, which will be detailed later. The hash value of the connection information is used, rather than the connection information itself, in order to prevent leakage of the connection information. Communication using the NAN cluster is communication that uses the data link layer and lower layers and does not use the network layer or higher layers of the OSI reference model. That is, communication using the NAN cluster has relatively low security. The hash value is communicated, rather than the connection information itself, using the NAN cluster in T72, thereby preventing leakage of the connection information.

The printer 10B receives the Publish including the hash value and the information “Connection OK” from the printer 10A using the NAN cluster in T72. Then, the printer 10B determines in T74 that the connection status of the printer 10A as the parent device changed. This is because the information indicating that an AP connection has not been established between the printer 10A and an AP is stored in the memory 34B of the printer 10B. Since the Publish received in T72 includes the information “Connection OK”, the printer 10B sends a Data Path Request to the printer 10A using the NAN cluster in T76. The Data Path Request is a signal that requests the printer 10A to establish a communication path (i.e., a Data Path) for sending the connection information.

The printer 10A receives the Data Path Request from the printer 10B using the NAN cluster in T76. In response, the printer 10A sends a Data Path Response to the printer 10B using the NAN cluster in T78.

The printer 10B receives the Data Path Response from the printer 10A using the NAN cluster in T78. In response, the printer 10B sends a Data Path Confirm to the printer 10A using the NAN cluster in T80. As a result, a Data Path is established between the printer 10A and the printer 10B in T82. Communication using the Data Path is communication that uses the network layer or higher layers of the OSI reference model. For establishing a Data Path between a pair of devices, authentication is executed between the pair of devices. In this authentication, information such as a NAN Identity Key (NIK) and NAN Pairing Key (NPK) is used. Thus, a wireless network formed by the Data Path has higher security than the NAN cluster.

The printer 10B sends a connection information request to the printer 10A using the established Data Path in T84. The connection information request is a signal that requests the printer 10A to send the connection information stored in the memory 34A of the printer 10A.

The printer 10A receives the connection information request from the printer 10B using the Data Path in T84. In response, the printer 10A sends the connection information stored in the memory 34A to the printer 10B using the Data Path in T86. As mentioned above, the wireless network formed by the Data Path has higher security than the NAN cluster. Therefore, the printer 10A can send the connection information to the printer 10B more securely than sending the connection information using the NAN cluster.

The printer 10B receives the connection information from the printer 10A using the Data Path in T86. The printer 10B then stores the received connection information in the memory 34B in T87. In this way, the connection information stored in the printer 10A as the parent device is shared with the printer 10B as a child device.

After storing the connection information in the memory 34B in T87, the printer 10B sends a Data Path Termination to the printer 10A in T88. As a result, the Data Path between the printers 10A and 10B disappears in T89.

Further, after the printer 10B stores the connection information, an AP connection process is executed in T90 to establish an AP connection between the printer 10B and the AP 6A. The AP connection process includes, for example, authentication of the connection information stored in the memory 34B. In the present case, the authentication of the connection information succeeds, so that an AP connection is established between the printer 10B and the AP 6A. As a result, the printer 10A and the printer 10B belong to the same wireless network formed by the AP 6A.

After establishing the AP connection with the AP 6A, the printer 10B shifts from the setting synchronization mode to the normal mode in T92. That is, the printer 10B does not send a Subscribe while the AP connection is established. This is because the printer 10B has already established the AP connection and therefore does not need to acquire connection information from another device. This reduces the processing load on the printer 10B.

Thereafter, the AP connection with the AP 6A is temporarily disconnected, for example, due to a temporary malfunction of the Wi-Fi I/F 16B of the printer 10B. In this case, the printer 10B shifts from the normal mode to the setting synchronization mode in T100. T102 is the same as T50 in FIG. 2. T104 is the same as T72.

The printer 10B receives a Publish including the hash value and the information “Connection OK” from the printer 10A in T104. The printer 10B then calculates a hash value by hashing the connection information stored in the memory 34B with a hash function. This hash function is the same as the hash function used by the printer 10A. Since the same connection information is hashed with the same hash function by the printers 10A and 10B, the hash value included in the Publish matches the hash value calculated by the printer 10B. In this case, the printer 10B determines in T106 that the connection status of the printer 10A as the parent device has not changed. In this case, the printer 10B does not execute the sequence from T76 to T89. This is because even if the sequence from T76 to T89 is executed in this situation, the printer 10B merely receives the connection information already stored in the memory 34B from the printer 10A again. The unnecessary steps are thus omitted.

Thereafter, the temporary malfunction of the Wi-Fi I/F 16B of the printer 10B is fixed and the AP connection between the printer 10B and the AP 6A is regained. In response, the printer 10B shifts from the setting synchronization mode to the normal mode in T108.

### Continuation from FIG. 3

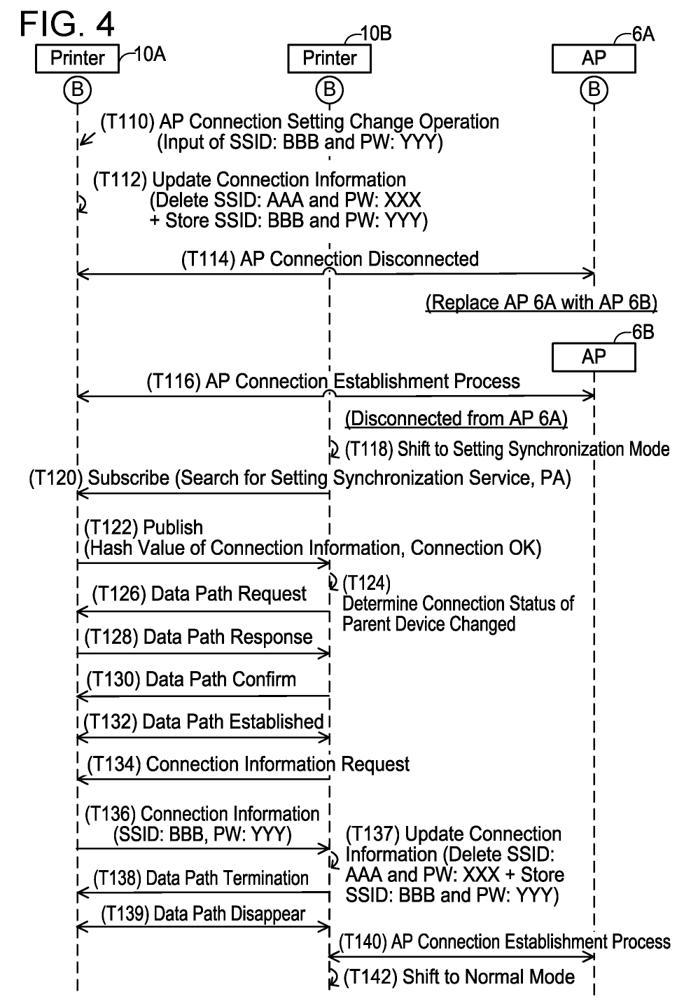

Here, a situation is assumed in which the AP 6B is newly installed in place of the AP 6A. In this case, the user performs an operation to establish an AP connection between the printer 10A and the AP 6B. Specifically, the printer 10A receives an AP connection setting operation from the user in T110 of FIG. 4 to establish an AP connection with the AP 6B. This AP connection setting operation includes input of the connection information of the AP 6B (i.e., the SSID “BBB” and the PW “YYY”). In T112, the printer 10A updates the connection information stored in the memory 34A. Specifically, the printer 10A deletes the connection information stored in the memory 34A and stores the connection information input in T110 in the memory 34A. That is, the printer 10A deletes the SSID “AAA” and the PW “XXX” and newly stores the SSID “BBB” and the PW “YYY”.

Due to the deletion of the SSID “AAA” and the PW “XXX” from the memory 34A, the AP connection between the printer 10A and the AP 6A is disconnected in T114. Then, in T116, an AP connection process is executed to establish an AP connection between the printer 10A and the AP 6B. This AP connection process includes authentication of the connection information stored in the memory 34A. In the present case, the authentication of the connection information succeeds, so that an AP connection is established between the printer 10A and the AP 6B. Thereafter, the AP 6A is removed.

Due to the removal of the AP 6A, the AP connection between the printer 10B and the AP 6A is disconnected. In response, the printer 10B shifts from the normal mode to the setting synchronization mode in T118. T120 is the same as T50 in FIG. 2. T122 is the same as T72 in FIG. 3 except for the hash value of the connection information. That is, the hash value included in the Publish sent in T122 is obtained by hashing the connection information of the AP 6B.

The printer 10B receives the Publish including the hash value and the information “Connection OK” from the printer 10A in T122. The printer 10B then calculates a hash value by hashing the connection information stored in the memory 34B with a hash function. This hash function is the same as the hash function used by the printer 10A. Since the connection information stored in the memory 34A of the printer 10A is different from the connection information stored in the memory 34B of the printer 10B (i.e., the former connection information is the connection information of the AP 6B and the latter connection information is the connection information of the AP 6A), the hash value included in the Publish is different from the hash value calculated by the printer 10B. In this case, the printer 10B determines in T124 that the connection status of the printer 10A as the parent device changed. Then, the printer 10B executes a sequence from T126 to T132 to establish a Data Path between the printer 10A and the printer 10B. The sequence from T126 to T132 is the same as the sequence from T76 to T82 in FIG. 3.

T134 is the same as T84 in FIG. 3. The printer 10A sends the connection information stored in the memory 34A to the printer 10B using the Data Path in T136. That is, the printer 10A sends the connection information of the AP 6B to the printer 10B.

The printer 10B receives the connection information from the printer 10A using the Data Path in T136. In response, the printer 10B updates the connection information stored in the memory 34B in T137. Specifically, the printer 10B deletes the connection information stored in the memory 34B and stores the received connection information in the memory 34B. That is, the printer 10B deletes the SSID “AAA” and the PW “XXX” and newly stores the SSID “BBB” and the PW “YYY”. In this way, in case the connection information is updated in the printer 10A as the parent device, the updated connection information is shared with the printer 10B as a child device.

T138 and T139 are the same as T88 and T89 in FIG. 3, respectively. T140 is the same as T90 in FIG. 3 except that the connection information of the AP 6B is used and an AP connection is established between the printer 10B and the AP 6B. T142 is the same as T92 in FIG. 3.

### Advantageous Effects of Embodiment

According to the configuration above, the printer 10A receives a Subscribe from the printer 10B using the NAN cluster (T70 in FIG. 3). In case the printer 10A receives a Subscribe from the printer 10B and wireless communication is executable between the printer 10A and the AP 6A using an AP connection, the printer 10A sends the connection information of the AP 6A to the printer 10B using a Data Path which has higher security than the NAN cluster (T86). Thus, the printer 10A can wirelessly communicate with the printer 10B via the AP 6A without the user inputting the connection information of the AP 6A to the printer 10B. Therefore, user convenience is improved.

The technology described in connection with the above embodiment is also useful to communication systems comprising three or more printers. In such a communication system, one printer operates as the parent device and the other two or more printers operate child devices. In this communication system as well, connection information input only to the parent device is shared with the child devices. Therefore, user convenience is improved.

Conventionally, technologies for sharing settings among devices within the same network through communication that uses the network layer or higher layers of the OSI reference model are known. However, such conventional technologies require devices among which settings are to be shared to join the same network in advance in order to use the communication using the network layer or higher layers. In contrast, the technology described in connection with the above embodiment starts sharing of connection information using a NAN cluster. As noted above, communication using a NAN cluster is communication that uses the data link layer and below and does not use the network layer or higher layers of the OSI reference model. Thus, according to the above embodiment, sharing of connection information is started without using communication that uses the network layer or higher layers of the OSI reference model.

### Correspondence Relationships

The printer 10A and the printer 10B are examples of “first communication device” and “second communication device”, respectively. The Wi-Fi I/F 16A of the printer 10A is an example of “Wi-Fi interface” and an example of “first Wi-Fi interface”. The Wi-Fi I/F 16B of the printer 10B is an example of “second Wi-Fi interface”. The AP 6A and the AP 6B are examples of “external device” and “specific external device”. The AP connection between the printer 10A and the AP 6A and the AP connection between the printer 10A and the AP 6B are examples of “first wireless connection”. The SSID “AAA” and the PW “XXX” of the AP 6A and the SSID “BBB” and the PW “YYY” of the AP 6B are examples of “connection information”. NAN clusters are examples of “first wireless network”. The wireless network formed by establishment of a Data Path is an example of “second wireless network”. Data path established between the printer 10A and the printer 10B is an example of “second wireless connection”. The parent device information (i.e., the serial number “PA” of the printer 10A) is an example of “identification information”. Subscribes are examples of “predetermined signal”. The connection information request communicated in T84 of FIG. 3 is an example of “connection information request”. The AP connection between the printer 10B and the AP 6A and the AP connection between the printer 10B and the AP 6B are examples of “third wireless connection”.

T50 in FIG. 2, T70 and T102 in FIG. 3, and T120 in FIG. 4 are examples of “receive a predetermined signal” by the first communication device. The sequence from T76 to T82 in FIG. 3 and the sequence from T126 to T132 in FIG. 4 are examples of “establish a second wireless connection between the first communication device and the second communication device” by the first communication device. T84 in FIG. 3 and T134 in FIG. 4 are examples of “receive a connection information request” by the first communication device. T86 in FIG. 3 and T136 in FIG. 4 are examples of “send the connection information” by the first communication device.

T50 in FIG. 2, T70 and T102 in FIG. 3, and T120 in FIG. 4 are examples of “send a predetermined signal” by the second communication device. T86 in FIG. 3 and T136 in FIG. 4 are examples of “receive the connection information” by the second communication device. T90 in FIG. 3 and T140 in FIG. 4 are examples of “establish a third wireless connection with the specific external device” by the second communication device.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

(Modification 1) For example, a process for establishing a wireless connection according to the Wi-Fi Direct scheme of the Wi-Fi standard may be executed between the printers 10A and 10B instead of the sequence from T76 to T82 in FIG. 3. In this modification, the wireless connection according to the Wi-Fi Direct scheme is an example of “second wireless connection”. A wireless network formed by the establishment of wireless connection according to the Wi-Fi Direct scheme is an example of “second wireless network”. Communication using the wireless connection according to the Wi-Fi Direct scheme has higher security than communication using a NAN cluster. That is, generally speaking, the “second wireless network” may be any kind of wireless network as long as it has higher security than the “first wireless network”.

(Modification 2) The printer 10B may not store the parent device information (i.e., the serial number “PA” of the printer 10A). In this modification, the printer 10B may send a Subscribe that does not include the serial number “PA” of the printer 10A in T50 of FIG. 2 and the like. In response to receiving the Subscribe from the printer 10B, the printer 10A may send a Publish and the connection information. Generally, “send the connection information” by the “first communication device” may include sending the connection information to the second communication device regardless of whether the predetermined information includes the identification information.

(Modification 3) The printer 10A may send parent device information including a NIK of the printer 10A to the printer 10B in T38. The printer 10B may send a Subscribe including a NIK in T50 and the like. In this modification, the NIK of the printer 10A is an example of “identification information”.

(Modification 4) T84 in FIG. 3 may be omitted. For example, in case a Data Path is established with the printer 10B (T82 in FIG. 3), the printer 10A may send the connection information to the printer 10B (T86). In this modification, “receive a connection information request” by the “first communication device” may be omitted.

(Modification 5) The printer 10B may operate in the setting synchronization mode regardless of whether an AP connection is established. That is, the printer 10B may periodically send a Subscribe regardless of whether an AP connection is established. Generally, “receive a predetermined signal” by the “first communication device” may include receiving the predetermined signal from the second communication device regardless of whether a wireless connection is established between the second communication device and the external device.

(Modification 6) In response to receiving a Publish from the printer 10A (T72, T104 in FIG. 3, etc.), the printer 10B may not determine whether the connection status of the parent device has changed. That is, the printer 10B may send a Data Path Request to the printer 10A (T76) in response to receiving a Publish from the printer 10A. Then, the printer 10B may receive the connection information from the printer 10A regardless of whether the connection status of the parent device has changed. That is, the printer 10A may send the connection information to the printer 10B regardless of whether the connection information stored in the printer 10A matches the connection information stored in the printer 10B. Generally, “send the connection information” by the “first communication device” may include sending the connection information to the second communication device regardless of whether the second communication device already stores connection information.

(Modification 7) The printers 10A and 10B may not display the query screen SC1 (T30, T32). For example, one of the printers 10A and 10B that establishes an AP connection with an AP earlier than the other may be determined as the parent device. Here, a situation is assumed in which the sequence from T60 to T64 is executed after T26 in FIG. 2 was executed, so that an AP connection is established between the printer 10A and the AP 6A. Upon the establishment of the AP connection with the AP 6A, the printer 10A may change the parent device flag to “ON” (T36) and send the parent device information to the printer 10B (T38). In response, the printer 10B may execute the sequence from T40 to T46 and operate as a child device.

(Modification 8) The printer 10A as the parent device may store a list of child devices that have registered the printer 10A as the parent device. For example, in response to receiving selection of the YES button in T42 of FIG. 2, the printer 10B may send a registration request including the serial number “PB” of the printer 10B to the printer 10A. In response to receiving the registration request, the printer 10A may add the serial number “PB” included in the registration request to the list of child devices. Further, in this modification, the printer 10B may not execute T44. The printer 10B then may send a Subscribe including the serial number “PB” instead of the serial number “PA” in T50 and the like. In case the serial number “PB” included in the Subscribe is on the list of child devices, the printer 10A may send a Publish.

(Modification 9) In the above embodiment, the steps in FIGS. 2-4 are executed by software (e.g., the programs 36A, 36B), however, at least one of these steps may be executed by hardware such as a logic circuit.

What is claimed is:

1. A first communication device comprising:
a Wi-Fi interface configured for wireless communication according to a Wi-Fi standard;
a memory configured to store connection information for establishing a first wireless connection according to the Wi-Fi standard with a specific external device; and
a controller,
wherein the controller is configured to:
in a state where the first communication device belongs to a first wireless network according to a Wi-Fi Aware scheme of the Wi-Fi standard, receive a predetermined signal via the Wi-Fi interface by using the first wireless network from a second communication device which belongs to the first wireless network; and
in a case where the predetermined signal has been received from the second communication device and wireless communication is executable by using the first wireless connection between the first communication device and the specific external device, send the connection information in the memory to the second communication device via the Wi-Fi interface by using a second wireless network which has higher security than the first wireless network.

2. The first communication device as in claim 1,
wherein in a case where the predetermined signal includes identification information for identifying the first communication device, the controller sends the connection information to the second communication device, and
in a case where the predetermined signal does not include the identification information, the controller does not send the connection information to the second communication device.

3. The first communication device as in claim 1,
wherein the controller is further configured to, in the case where the predetermined signal has been received from the second communication device and wireless communication is executable by using the first wireless connection between the first communication device and the specific external device, establish a second wireless connection between the first communication device and the second communication device via the Wi-Fi interface,
wherein the second wireless network is formed by establishing the second wireless connection between the first communication device and the second communication device.

4. The first communication device as in claim 3,
wherein the controller is further configured to, in a case where the second wireless connection is established between the first communication device and the second communication device, receive a connection information request from the second communication device by using the second wireless network,
wherein in a case where the connection information request is received from the second communication device, the controller sends the connection information to the second communication device by using the second wireless network.

5. The first communication device as in claim 3,
wherein the second wireless connection is established according to the Wi-Fi Aware scheme.

6. The first communication device as in claim 1,
wherein in a case where a wireless connection is not established between the second communication device and an external device, the controller receives the predetermined signal from the second communication device by using the first wireless network, and
in a case where a wireless connection is established between the second communication device and the external device, the controller does not receive the predetermined signal from the second communication device.

7. The first communication device as in claim 6,
wherein in a case where the second communication device does not store the connection information, the controller sends the connection information to the second communication device by using the second wireless network, and
in a case where the second communication device stores the connection information, the controller does not send the connection information to the second communication device.

8. The first communication device as in claim 1,
wherein the first wireless network is a Neighbor Awareness Networking (NAN) cluster defined in the Wi-Fi Aware scheme, and
the predetermined signal is a Subscribe defined in the Wi-Fi Aware scheme.

9. A non-transitory computer-readable storage medium storing computer-readable instructions for a first communication device,
wherein the first communication device comprises:
a Wi-Fi interface configured for wireless communication according to a Wi-Fi standard;
a memory configured to store connection information for establishing a first wireless connection according to the Wi-Fi standard with a specific external device; and
a processor,
wherein the computer-readable instructions, when executed by the processor, cause the first communication device to:
in a state where the first communication device belongs to a first wireless network according to a Wi-Fi Aware scheme of the Wi-Fi standard, receive a predetermined signal via the Wi-Fi interface by using the first wireless network from a second communication device which belongs to the first wireless network; and
in a case where the predetermined signal has been received from the second communication device and wireless communication is executable by using the first wireless connection between the first communication device and the specific external device, send the connection information in the memory to the second communication device via the Wi-Fi interface by using a second wireless network which has higher security than the first wireless network.

10. A communication system comprising:
a first communication device; and
a second communication device,
wherein the first communication device comprises:
a first Wi-Fi interface configured for wireless communication according to a Wi-Fi standard; and
a memory configured to store connection information for establishing a first wireless connection according to the Wi-Fi standard with a specific external device,
wherein the second communication device comprises:
a second Wi-Fi interface configured for wireless communication according to the Wi-Fi standard; and
a second controller configured to, in a state where the first communication device and the second communication device both belong to a first wireless network according to a Wi-Fi Aware scheme of the Wi-Fi standard, send a predetermined signal via the second Wi-Fi interface by using the first wireless network,
wherein the first communication device further comprises a first controller configured to:
receive the predetermined signal via the first Wi-Fi interface by using the first wireless network from the second communication device; and
in a case where the predetermined signal has been received from the second communication device and wireless communication is executable by using the first wireless connection between the first communication device and the specific external device, send the connection information in the memory to the second communication device via the first Wi-Fi interface by using a second wireless network which has higher security than the first wireless network,
wherein the second controller is further configured to:
receive the connection information via the second Wi-Fi interface by using the second wireless network from the first communication device; and
in a case where the connection information is received from the first communication device, establish a third wireless connection with the specific external device via the second Wi-Fi interface by using the connection information.
